(19) United States
(12) Patent Application Publication
(10) Pub. No.: US 2016/0092945 A1
(43) Pub. Date: Mar. 31, 2016

(54) Quality Users Information Employed For Improved User Experience Including Ratings And Recommendations

(71) Applicant: Apple Inc., Cupertino, CA (US)

(72) Inventors: Geoff Stahl, San Jose, CA (US); Jacques P. Gasselin de Richebourg, Sunnyvale, CA (US); Nate Begeman, Cupertino, CA (US)

(21) Appl. No.: 14/869,659

(22) Filed: Sep. 29, 2015

Related U.S. Application Data
(60) Provisional application No. 62/057,113, filed on Sep. 29, 2014.

(51) Int. Cl. G06Q 30/02; H04L 29/08

(52) U.S. Cl. CPC G06Q 30/0282; G06Q 30/0201; H04L 67/306

(57) ABSTRACT

An apparatus, method, and computer readable medium related to monitoring computer users to acquire information regarding use of application programs and device features as well as the context of such use. Computer users are monitored and data is collected to indicate the computer users' activities including the use of any particular application program. Profiles of each computer user may be created where the profiles are an aggregate of the collected information or a portion thereof. The Profiles may correlated to determine relationships between user behaviors. Various analytics regarding the relationship information may be employed to improve customer-oriented information such as ratings, recommendations, customer support, marketing, communications, and product features design.

### CROSS-REFERENCE TO RELATED APPLICATIONS

This application claims priority to U.S. provisional patent application No. 62/057,113, entitled “Quality Users Information Employed For Improved User Experience Including Ratings And Recommendations,” which was filed on Sep. 29, 2014 and is incorporated by reference in its entirety.

### BACKGROUND

Any service or item that is used or sold may be related to its user or potential user by a variety of criteria, where each item of criteria relates to the user's use of the item or the context of that use. One example of relating product criteria to a user occurs in the area of ratings. Customers or users apply their personal rating to all types of products and services such as software, dining, movies, consumer products, etc. Most rating systems rely on user comments and only a few metrics to illustrate why the user liked or didn't like a product or service. For example, a typical restaurant rating service may show noise level, food quality and service as separate ratable criteria, but to truly understand the user's experience, a reader must closely review comments provided by the rating user (e.g. a user that has purchased the product or service and provided a rating). In order to understand the usefulness of any particular rating, the reading user (e.g. a user considering the purchase of a product or service and reading the ratings provided by other users) may typically try to understand how well she relates to the perspective of the rating user. In other words, the reading user should try to use the rating user as a reference and determine whether the reference may be relied upon to indicate whether the reading user would share the opinion of the rating user. The more that is known about the reading user and the rating user, the more rich and therefore valuable ratings information can be. This is because a system can automatically correlate reading users with rating users to determine their compatibility.

Matching information about product and service users/buyers with potential user/buyers has applications far beyond just ratings. For example, similar information can be used to make recommendations to shoppers or to change or optimize product features as well as sales and marketing strategies and tactics. In addition, matching and analyzing information about buyers and users of a product or service can reveal very useful information for product improvement and customer satisfaction improvement.

One issue with exploiting user data for ratings, recommendations, and other customer oriented issues is that manufacturers and sellers are incented to game the system by providing contrived reviews, ratings, and other feedback information to the services that inform consumers. There are many ways to contrive ratings and other feedback information. For example, farms of paid users may be employed by a manufacturer or developer or the developer may unfairly influence real users to artificially inflate ratings. If a service relies on the contrived information, the output of the service will be skewed, for example, resulting in artificially high ratings, inappropriate recommendations, or sub-optimal marketing, sales, and customer service tactics and strategies.

### SUMMARY

A “quality user” or “user quality” profile represents a set of metrics derived from a variety of data regarding a user's (or potentially a device's) use of a particular product or service (e.g. an application program) and the context of that use. At a high level, in certain embodiments, one metric for a quality user profile is a rating for the user (and/or the host device) that indicates how much the user's behaviors should be considered in rating or recommending the product to others. For example, assuming a scale from zero to 10 is applied to each metric of a “quality user” profile, the zero side of the scale correlates with a user whose feedback and use-related information should be totally disregarded. A zero rating might apply to a user that is paid by the application developer to use and rate the application in order to artificially increase ratings and recommendations, and thereby actually increase sales. Alternatively, a 10 rating (on the zero-10 scale) may apply to a genuine user, where the particular product represents a significant amount of the user's time using one or more devices. Of course, the exact behaviors or contextual facts that correlate with a zero or 10 (or any other) rating may vary between products based upon the details of that product and its users. For example, in the area of gaming software, the most representative enthusiastic users of one game may spend many hours using the game, while for a second game, the total use time may be less important than number of game openings/accesses or the amount of in-game purchases.

With respect to an overall quality user profile, the importance of any particular contextual or behavioral use metric may be determined in any of several ways: by software algorithm; by the developer/manufacturer/service provider; by the developer in cooperation with one or more resellers; by the proprietor of a particular source or store; by independent third parties; or by any combination of the foregoing. In addition, with respect to software, in determining the importance of use metrics for a particular software product, analytics may be employed on prior use of either the software or the host devices. For example, in evaluating use behaviors, data may be acquired regarding an identified user or an identified device or both. In some instances one or another will be available and when both are available, certain embodiments may exploit either or both.

In addition, the importance of any particular contextual or behavioral metric may change over time as either: past use data yields more insight; or external data (e.g. consumer surveys or identity of paid users) is obtained regarding identified users or devices that sheds light on previously collected behavioral and contextual data. For example, if a software store proprietor develops an algorithm for determining whether a user is genuine or contrived, that algorithm will be based upon the varying importance of certain specific use and contextual metrics. However, as more data is gathered or external data is obtained, it may be desirable to alter the algorithm based upon newer data analytics.

For some embodiments, the quality user profile will have different common characteristics or patterns that associate with a software application's desirability either generally or for a certain demographic of users. For example, the quality user profile may have a certain characteristic pattern for a good game; a different characteristic patter for a medium game; yet a different pattern for a bad game; and even another pattern for a suspicious use associated with a developer trying to cheat the rating or recommendation system. In general, the quality user profile can be employed to emphasize the metrics for a particular user or device so that ratings and recommendations can rely more on users that genuinely like or do not like an application for its intended use. Similarly, the quality user profile allows ratings and recommendations to rely less on users that are contrived, sampling, surfing, or merely experimenting without experiencing the application enough to become a reliable reference for ratings and recommendations.

Quality user profiles may also be used to improve monetization and profitability for application developers and sellers. For example, the profiles may be analyzed to determine the correlation of different use and contextual metrics with the amount of in-application purchases. The developer can make changes to the application or the in-application purchase strategy to take advantage of the correlations. This may result in higher profits and revenue as well as more satisfied application users (presumably users pay for what they enjoy or view most important). As another example, a developer may notice that they have too many low quality users or that they have many high quality users, but those high quality users are not correlating with more revenue and profit. The developer or seller of an application can use the quality user profiles to increase revenue, profit and customer satisfaction by incenting usage patterns that correlate with revenue and converting low quality users to high quality users (presumably those with higher revenue usage patterns)

Ratings and recommendations can be further refined by matching quality user profile patterns of a shopper with a previous buyer. For example, a user that is shopping for applications may gain more information if the ratings and recommendations provided during the shopping experience are biased to overweight users that have profile patterns that are either similar to the shopper or that correlate with the shopper. The bias can be implemented either automatically by the system providing ratings and recommendations or the shopper can be given the ability to bias the ratings herself (e.g. by separately rating products based upon raters having certain profile patterns or by asking the system to mathematically bias the results toward certain profile patterns). In addition, quality user profile patterns may vary by geography, culture, habits, interests or any user characteristics or context derived on or off a host system or application.

### BRIEF DESCRIPTION OF THE DRAWINGS

FIG. 1 shows a representative hardware environment.

FIG. 2 shows a representative network environment.

FIG. 3 shows representative software architecture.

FIG. 4 shows a conceptual organization of hardware, software and function for some embodiments of the invention.

FIG. 5 shows a generic quality user profile associated with some embodiments of the invention.

FIG. 6 shows an illustrative quality user profile associated with some embodiments of the invention.

FIG. 7 illustrates ratings user interfaces associated with some embodiments of the invention.

FIG. 8 illustrates an exemplary recommendations interface.

FIG. 9 shows an illustrative process associated with embodiments of the invention.

### DETAILED DESCRIPTION

The inventive embodiments described herein may have implication and use in and with respect to all types of devices, including single and multi-processor computing systems and vertical devices (e.g. cameras or appliances) that incorporate single or multi-processing computing systems. The discussion herein references a common computing configuration having a CPU resource including one or more microprocessors. The discussion is only for illustration and not intended to confine the application of the invention to the disclosed hardware. Other systems having other known or common hardware configurations (now or in the future) are fully contemplated and expected. With that caveat, a typical hardware and software operating environment is discussed below. The hardware configuration may be found, for example, in a server, a laptop, a tablet, a desktop computer, a phone, or any computing device, whether mobile or stationary.

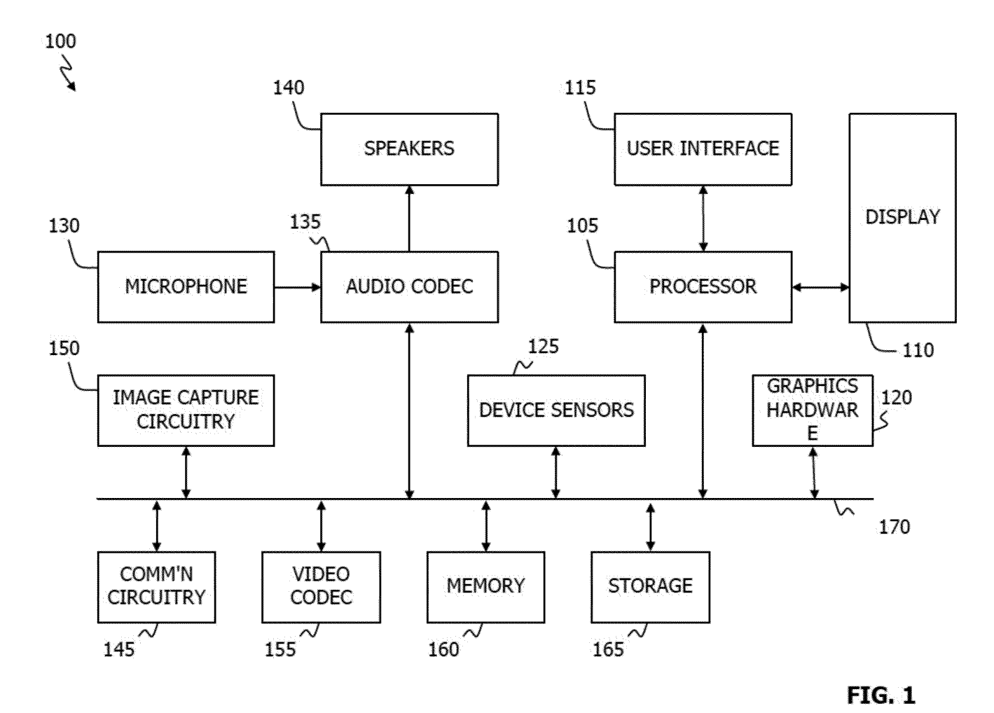

Referring to FIG. 1, a simplified functional block diagram of illustrative electronic device 100 is shown according to one embodiment. Electronic device 100 could be, for example, a mobile telephone, personal media device, portable camera, or a tablet, notebook or desktop computer system or even a server. As shown, electronic device 100 may include processor 105, display 110, user interface 115, graphics hardware 120, device sensors 125 (e.g., GPS, proximity sensor, ambient light sensor, accelerometer and/or gyroscope), microphone 130, audio codec(s) 135, speaker(s) 140, communications circuitry 145, image capture circuitry 150 (e.g. camera), video codec(s) 155, memory 160, storage 165 (e.g. hard drive(s), flash memory, optical memory, etc.) and communications bus 170. Communications circuitry 145 may include one or more chips or chip sets for enabling cell based communications (e.g., LTE, CDMA, GSM, HSDPA, etc.) or other communications (WiFi, Bluetooth, USB, Thunderbolt, Firewire, etc.). Electronic device 100 may be, for example, a personal digital assistant (PDA), personal music player, a mobile telephone, or a notebook, laptop, tablet computer system, or any desirable combination of the foregoing.

Processor 105 may execute instructions necessary to carry out or control the operation of many functions performed by device 100 (e.g., such to run applications like games and agent or operating system software to observe and record user behaviors and the context of those behaviors). In general, many of the functions described herein are based upon a microprocessor acting upon software (instructions) embodying the function. Processor 105 may, for instance, drive display 110 and receive user input from user interface 115. User interface 115 can take a variety of forms, such as a button, keypad, dial, a click wheel, keyboard, display screen and/or a touch screen, or even a microphone or camera (video and/or still) to capture and interpret input sound/voice or images including video. The user interface 115 may capture user input for any purpose including for use as application ratings information or search information or a response to recommendations.

Processor 105 may be a system-on-chip such as those found in mobile devices and include a dedicated graphics processing unit (GPU). Processor 105 may be based on reduced instruction-set computer (RISC) or complex instruction-set computer (CISC) architectures or any other suitable architecture and may include one or more processing cores. Graphics hardware 120 may be special purpose computational hardware for processing graphics and/or assisting processor 105 to process graphics information. In one embodiment, graphics hardware 120 may include one or more programmable graphics processing units (GPU).

Sensors 125 and camera circuitry 150 may capture contextual and/or environmental phenomenon such as location information, the status of the device with respect to light, gravity and the magnetic north, and even still and video images. All captured contextual and environmental phenomenon may be used to contribute to descriptions (e.g. metrics) of users' behaviors and the context of those behaviors with respect to a device or any particular application program that may be running on a device. Output from the sensors 125 or camera circuitry 150 may be processed, at least in part, by video codec(s) 155 and/or processor 105 and/or graphics hardware 120, and/or a dedicated image processing unit incorporated within circuitry 150. Information so captured may be stored in memory 160 and/or storage 165 and/or in any storage accessible on an attached network. Memory 160 may include one or more different types of media used by processor 105, graphics hardware 120, and image capture circuitry 150 to perform device functions. For example, memory 160 may include memory cache, electrically erasable memory (e.g., flash), read-only memory (ROM), and/or random access memory (RAM). Storage 165 may store data such as media (e.g., audio, image and video files), computer program instructions, or other software including database applications, preference information, device profile information, and any other suitable data. Storage 165 may include one more non-transitory storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 160 and storage 165 may be used to retain computer program instructions or code organized into one or more modules in either compiled form or written in any desired computer programming language. When executed by, for example, processor 105, such computer program code may implement one or more of the acts or functions described herein.

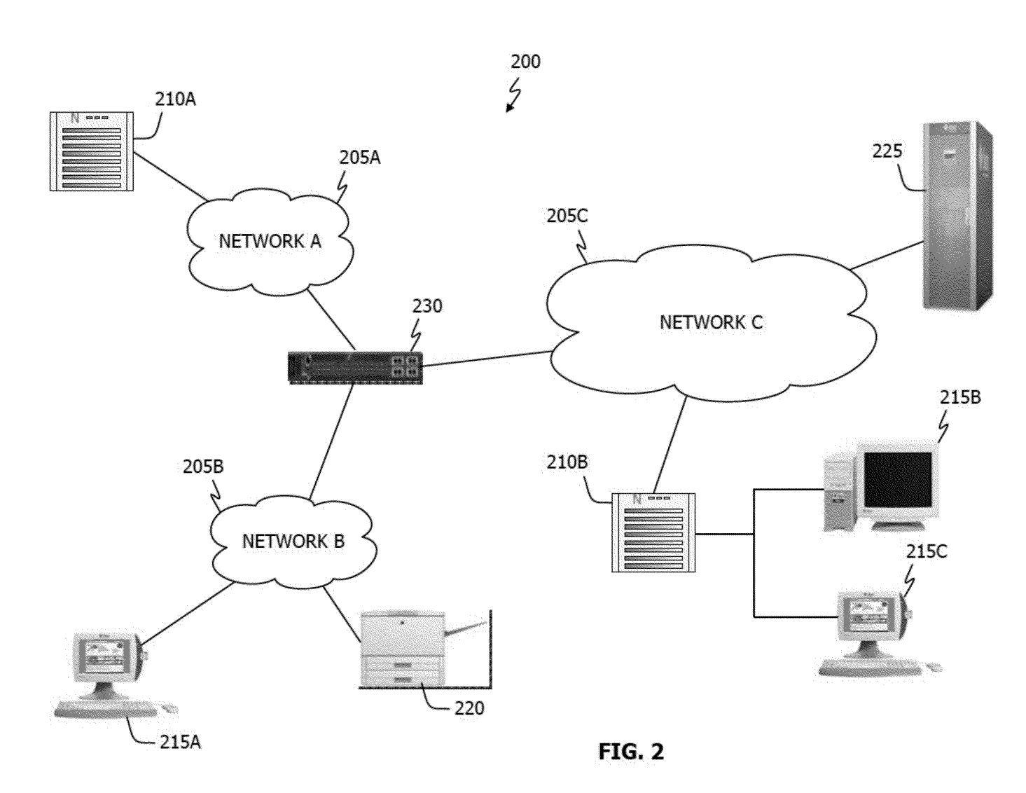

Referring now to FIG. 2, illustrative network architecture 200, within which the disclosed techniques may be implemented, includes a plurality of networks 205, (i.e., 205A, 205B and 205C), each of which may take any form including, but not limited to, a local area network (LAN) or a wide area network (WAN) such as the Internet. Further, networks 205 may use any desired technology (wired, wireless, or a combination thereof) and protocol (e.g., transmission control protocol, TCP). Coupled to networks 205 are data server computers 210 (i.e., 210A and 210B) that are capable of operating server applications such as databases and also capable of communicating over networks 205. One embodiment using server computers may involve the operation of one or more central systems to collect, process, and distribute user behavior, contextual information, or other information to and from other servers as well as mobile computing devices, such as smart phones or network connected tablets.

Also coupled to networks 205, and/or data server computers 210, are client computers 215 (i.e., 215A, 215B and 215C), which may take the form of any computer, set top box, entertainment device, communications device, or intelligent machine, including embedded systems. In some embodiments, users will employ client computers in the form of smart phones or tablets. Also, in some embodiments, network architecture 210 may also include network printers such as printer 220 and storage systems such as 225, which may be used to store multi-media items (e.g., images) that are referenced herein. To facilitate communication between different network devices (e.g., data servers 210, end-user computers 215, network printer 220, and storage system 225), at least one gateway or router 230 may be optionally coupled there between. Furthermore, in order to facilitate such communication, each device employing the network may comprise a network adapter. For example, if an Ethernet network is desired for communication, each participating device must have an Ethernet adapter or embedded Ethernet capable ICs. Further, the devices may carry network adapters for any network in which they will participate.

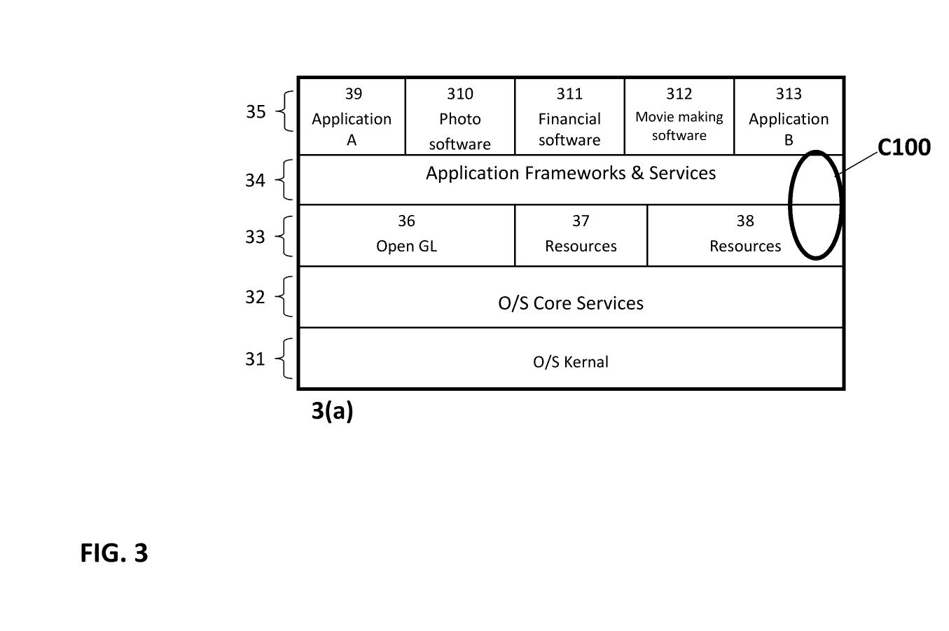

As noted above, embodiments of the inventions disclosed herein include software. As such, a general description of common computing software architecture is provided as expressed in layer diagrams of FIG. 3. Like the hardware examples, the software architecture discussed here is not intended to be exclusive in any way but rather illustrative. This is especially true for layer-type diagrams, which software developers tend to express in somewhat differing ways. In this case, the description begins with layers starting with the O/S kernel, so lower level software and firmware has been omitted from the illustration but not from the intended embodiments. The notation employed here is generally intended to imply that software elements shown in a layer use resources from the layers below and provide services to layers above. However, in practice, all components of a particular software element may not behave entirely in that manner.

With those caveats regarding software, referring to FIG. 3, layer 31 is the O/S kernel, which provides core O/S functions in a protected environment. Above the O/S kernel is layer 32 O/S core services, which extends functional services to the layers above, such as disk and communications access. Layer 33 is inserted to show the general relative positioning of the Open GL library and similar application and framework resources. Layer 34 is an amalgamation of functions typically expressed as multiple layers: applications frameworks and application services. For purposes of our discussion, these layers provide high-level and often functional support for application programs which reside in the highest layer shown here as item 35. Item C100 is intended to show the general relative positioning of the agent software, including any client side agent software described for some of the embodiments of the current invention. In particular, in some embodiments, agent software (or other software) that observes user behaviors (including context) and the behavior of applications such as games may reside below the application layer and above the operating system. In addition, some user behaviors may be expressed directly by the user through a user interface (e.g. the response to a question regarding application rating or feature preference). Since the observation of these behaviors may require a user interface, software may be required in the application layer. Further, some user behaviors are monitored by the operating system, and embodiments of the invention herein contemplate enhancements to an operating system to observe and track more user behaviors; such embodiments may use the operating system layers to observe and track user behaviors. While the ingenuity of any particular software developer might place the functions of the software described at any place in the software stack, the software hereinafter described is generally envisioned as all of: (i) user facing, for example, to receive ratings or provide recommendations; (ii) as a utility, or set of functions or utilities, beneath the application layer, for tracking and recording user behaviors and the context of those behaviors; and (iii) as one or more server applications for organizing, analyzing, and distributing user behavior information and analytics that may depend on that information including ratings and recommendations. Furthermore, on the server side, certain embodiments described herein may be implemented using a combination of server application level software, database software, with either possibly including frameworks and a variety of resource modules.

No limitation is intended by these hardware and software descriptions and the varying embodiments of the inventions herein may include any manner of computing device such as Macs, PCs, PDAs, phones, servers, or even embedded systems.

Some embodiments of the invention employ a concept of user quality or a “quality user.” Generally, a user may be considered to be high quality if her use of an item (application, genre of applications, device, etc.) is considered representative of other users. The other users may be typical users or a category of users defined by use behaviors and context, demographics or some other sorting mechanism. Also generally, a user may be considered low quality if her use of an item (application, genre of applications, device, etc.) is contrived or more arbitrary when compared to a group of other users. For example, the user's behavior is contrived if the user is paid by a developer to perform use scenarios. Similarly, a user's behavior is arbitrary when the user's behaviors do not correlate well with the behavior of other legitimate users, and perhaps even similarly situated other legitimate users. As used in this disclosure, the concept of a “quality user” or user quality simply represents a set of data (including a single or many aspects) indicating how well one or more users represents the behavior of other users for a given purpose; the purpose being potentially very broad (e.g. use of mobile devices) or more narrow (e.g. use of a particular game on a particular type of device), or anywhere in-between.

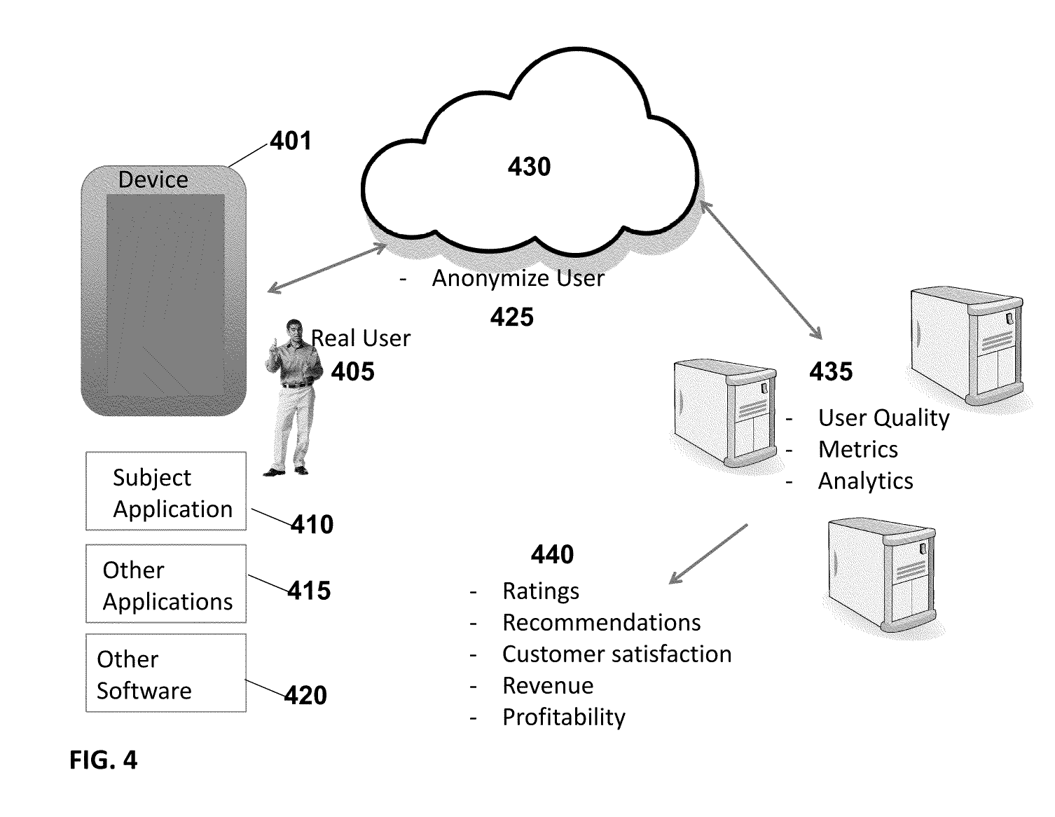

FIG. 4 is a very high-level diagram describing how some embodiments of the invention collect, assemble, and employ user behavior and context information that may contribute to a user quality profile. With reference to FIG. 4, device 401 is a client device that is pictured as a mobile device but may represent any type of device that a user may employ to run software, such as game software. Device 401 may include any of the hardware forms discussed above and run any of the software. However, device 401 is illustrated in FIG. 4 to include at least a subject application 410, other applications 415, and other software 420. The subject application 410 represents a particular application program run on device 401 by real user 405. Some embodiments of the invention may employ a set of user behavior and context data that represents the user quality of real user 405 with respect to subject application 410. For example, if subject application 410 is a driving game, the user quality of real user 405 with respect to the driving game might be represented by data showing how often the game is used, for how long and at what time of day.

In some embodiments, other applications 415 represents the other applications present on device 401 or the other applications on device 401 that are or have been used by real user 405. Real user 405's behavioral data with respect to the other applications may be employed as user quality data with respect to subject application 410, any one or more of other applications 415, or anything else relating to the user's behavior on device 401 or elsewhere. For example, the use of subject application 410 may be viewed in light of comparatively: how often one or more of other applications 415 are used; the genres of other applications 415; the sources of any of the applications, etc. In addition, some embodiments employ other software 420 to represent system software such as an operating system or specialty software such as agent software, either of which may be employed to observe and/or track user behaviors and context with respect to device 401, subject application 410 or other applications 415.

Referring again to FIG. 4, real user 405 represents use of application software on device 401. While real user 405 is illustrated as a specific person, the concept is intended to represent whatever level of use data is available or desired with respect to the user identity. For example, real user 405 may represent a specific user that is identified on device 401 through a personal authentication (e.g. such as when using an operating system offering multiple user accounts and profiles). However, real user 405 may also represent: the overall usage of the device 401 (e.g. where the real user 405 is synonymous with the device); a user of a particular application such as subject application 410; a user of a group of applications such as a genre; a presumed user as distinguished by user behaviors from one or more other presumed users of device 401; or any logical division of the operation of device 405. Further, in some embodiments of the invention, behavioral information regarding real user 405 may be augmented by information concerning real user 405's use of other devices or a marketing, financial, or personal profile available from sources outside device 401. As we discuss below, most embodiments of the invention seek to protect the privacy of a user by anonymizing the identity of a user prior to assembling and/or using behavioral and contextual information on a server or elsewhere that could compromise the user's privacy. However, in the user's own set of devices (e.g. phone, tablet, laptop, desktop, etc.) and accounts (e.g. Internet based accounts such as gmail, Facebook, Twitter, etc.), the personal identity of the user may be known so that information may be aggregated from multiple sources prior to being anonymized to protect the user's privacy.

Referring again to FIG. 4, user behavioral and contextual information may be transmitted from Device 401 over a network 430, such as the Internet, to servers 435. The behavioral information may be transmitted in any suitable way at any convenient interval. For example, information may be transmitted as it is collected, or it may be held for a time or until a quantum is obtained prior to transmission. In addition, information may be held to await an available network or a desirable networks status (e.g. desirable speed, low cost, desirable security).

As illustrated above with respect to the representative hardware discussion, servers 435 may be one or more computers cooperating together. Individual computers that make up server 435 may be co-located or geographically dispersed.

In most embodiments, the user's real or actual identification will be cleansed from the data in order to protect the privacy of the real user's 405 identity. Other embodiments may allow for maintaining real or actual identity of the user with consent. The behavioral data may be cleansed of identifying information either before the data is transmitted from device 401 or after the data is received at server 435. By moving the data to the server before cleansing identity, there may be more opportunity to aggregate with other data relating to a specific user. For example, online vendors typically retain purchase history, address, and financial information of customers. In one embodiment, a user account or registration on the server 435 may be used as an aggregation point for data regarding the user. The data may, for example, include user behaviors and context with respect to multiple devices (e.g. phone, tablet, laptop, etc.) and multiple data sources (e.g. online store data, or other Internet activity of the user). This aggregated data may be securely retained subject to a published privacy policy. The aggregated data may also be cleansed of user-identifying information by using an anonymous proxy for a user indication. The cleansed data may be pooled with data from other users and employed for ratings, recommendations, quality control, marketing, product research, etc.

Once at the server, user behavioral and contextual data may be organized by metrics and used to assemble user quality profiles and/or to perform analytics. As discussed above, there may be a variety of user quality measures because each user may have a quality profile with respect to several references, e.g. user quality profile for an application, user quality profile for a genre of applications, user quality profile with respect to the user's device, etc. Finally, as shown in FIG. 4, in addition to deriving user quality profiles, analytics on the user behavioral and contextual data may be employed in: ratings for items such as application software or devices; recommendations of software, devices or other products for users; determining techniques and strategies to improve customer satisfaction; and determining techniques and strategies to improve profits and revenue. Of course, the uses of the analytics are not limited to the examples shown in FIG. 4 and can relate to any operational concern of a business.

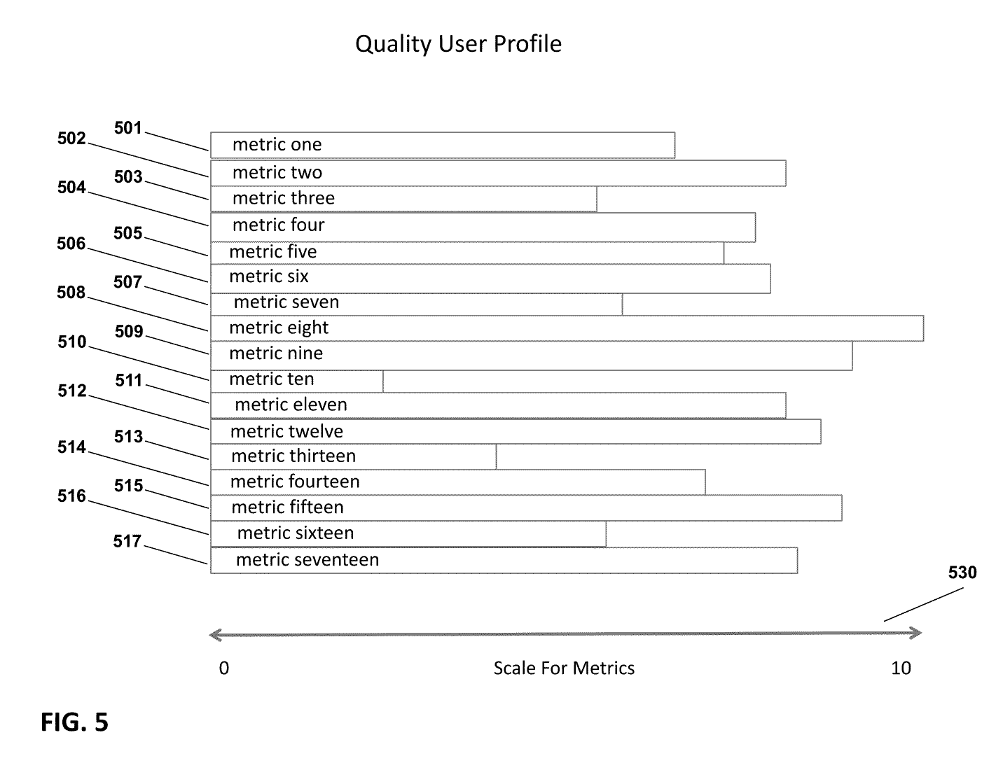

Referring now to FIG. 5, there is shown an illustrative quality user profile or measure for a particular user (whether anonymous or identified). The example embodiment shows consideration of seventeen metrics. Each metric in the illustration is scored with respect to scale 530. The scores vary between zero and 10 to indicate whether the metric strongly applies to the user (e.g. 10) or does not apply at all (e.g. 0). Of course, the profile may include any number of metrics and any scale or scoring system. In addition, rather than a scale or scoring system, some metrics may be represented by actual behavioral data. For example, for metrics like the following, actual data may be most useful: average minutes of application use per day/week/month; total minutes application use per day/week; month; ratio of time using a particular application versus all application on a specific device or for a particular user. Of course, the profile may include other metrics that are most suited for a scaled score, e.g. the likelihood the user is genuine, the proclivity of the user to make in-app purchases, or the presumed user preference for a certain genre of application. Generally, if a metric can be measured objectively, the use of real data may be appropriate rather than a scaled score. Alternatively, metrics that are derived from real data using an algorithm or subjective analysis may be more appropriate for a scaled score. None of this illustration, however, is intended to confine the invention to employing a certain type of scale or using actual data for any particular metric.

With reference to FIG. 5, the illustrated quality user profile is merely populated with generic metrics labeled as metric one 501, metric two 502 and so on to metric seventeen 517. Actual metrics used for any particular user quality measurement or profile may depend upon the reference for the user quality profile and may include significant contextual information such as the user's use of hardware and/or software as well as demographic and personal preference information about a user. There are many more specific types of user behavior and other metrics contemplated for varying embodiments of the invention.

One category of metrics contemplated by certain embodiments of the invention relates to a subject application or any application under consideration for data collection. For example if device 401 has or acquires a specific application, there are several metrics that may be observed and recorded with respect to that application program and associated with the user:
a. The identity of the application under consideration and its feature set, including multi-user support, GameCenter or similar support for a cooperative networked environment, controller, or accessory support, etc.
b. The amount paid for the application (including $0, to effectively answer the question of whether the application was purchased or free).
c. Whether the user had a payment method on file with the application source (e.g. a credit card or PayPal account on file at the App store).
d. Ratings for the subject application provided by the user for the subject application and other applications, and when the ratings were provided.
e. The location, time and/or date of each time the application is opened, which may also effectively reveal several other metrics:
   i. The number of times the application is opened during any particular time interval, e.g. day, week, month, year, ever.
   ii. The recency of opening the program, potentially including: the amount of time elapsed since the last time the application was opened or since the application was acquired, installed, updated or published; the amount of time elapsed since each time the program was opened; and the average time elapsed since the prior program openings during a defined interval, such as the prior week or month.
   iii. How many times the user opened the program.
   iv. The distribution of program opening times with respect to a day, circadian rhythm, normal work hours, normal sleep hours, week, work week, month, or other intervals (e.g. opened mostly on weekdays between 7 and 11 PM, with only sparse openings at other times)
   v. The motion of the host device each time the application was opened (e.g. the approximate speed of motion of the host device in motion when the program was opened).
   vi. The average number of times the application was opened each hour, day, month or other designated time interval. The average may be taken over the entire life of the application on a device or over a time period such as a recent time period (the prior day, week, month, etc.).
   vii. The rate of change of program openings over a time interval (e.g. during the prior month the number of daily openings increased).
f. Session lengths (e.g. each time the application is opened, how long is it used, in the device's foreground, or actively used), which may also effectively reveal several other metrics:
   i. The average session time during any particular time interval, e.g. day, week, month, year, ever.
   ii. The recency of sessions, potentially including: the amount of time elapsed since the last session of a certain length (e.g. above 10 minutes); and, the average time elapsed between sessions of a certain length (e.g. over 10 minutes)
   iii. Overall session time.
   iv. The average session time over a time interval (e.g. during the last day, week, month, etc.)
   v. The distribution of session lengths with respect to a day, normal work hours, circadian rhythm, normal sleep hours, week, work week, month, or other intervals (e.g. longer sessions (e.g. over 20 minutes) mostly on weekdays between 7 and 11 PM, with only very short session (e.g. under 5 minutes) at other times)
   vi. The motion of the host device during each session (e.g. the approximate distance covered or geography traversed during each session).
   vii. The average session time each day, month or other designated time interval. The average may be taken over the entire life of the application on a device or over a time period such as a recent time period (the prior day, week, month, etc.).
   viii. The rate of change of session times over a time interval (e.g. during the prior month the session times are increasing or the average daily session time is increasing, etc.).
g. How extensively the features of the application are exercised (e.g. each time the application used, which features of the application are used), which may also effectively reveal several other metrics:
   i. The total number or identity of features or most common features used during any particular time interval, e.g. day, week, month, year, ever.
   ii. The recency of each feature used potentially including the amount of time elapsed since each feature or selection of features has been accessed.
   iii. The average feature set or number of features used over a time interval (e.g. during the last day, week, month, etc.)
   iv. The distribution of features used with respect to a day, circadian rhythm, normal work hours, normal sleep hours, week, work week, month, or other intervals (e.g. some features used in the morning but never at night).
   v. The motion of the host device during the use of each feature (e.g. the approximate distance covered or geography traversed while a particular feature is in use).
   vi. The average number of features or set of features used each day, month or other designated time interval. The average may be taken over the entire life of the application on a device or over a time period such as a recent time period (the prior day, week, month, etc.).
   vii. The rate of change of feature use over a time interval (e.g. during the prior month the user increased their feature use or the average daily number of features used is increasing, etc.).
h. In-application purchase information (e.g. each time the application is opened, the amount of money spent on in-application purchases, and exactly what is purchased), which may also effectively reveal several other metrics:
   i. The average spent on in-application purchases during any particular time interval, e.g. day, week, month, year, ever.
   ii. The recency of in application purchases, potentially including: the amount of time elapsed since the last in-application purchase or since an in-application purchase exceeded a threshold; and, the average time elapsed between in-application purchases or in application purchases over a threshold.
   iii. Overall total of in-application purchases.
   iv. The amount of refunds of in-application purchases and whether there has been a request for a refund.
   v. The average amount of in-application purchases over a time interval (e.g. during the last day, week, month, etc.)
   vi. The distribution of in-application purchases with respect to a day, circadian rhythm, normal work hours, normal sleep hours, week, work week, month, or other intervals (e.g. in-application purchases or those over a threshold mostly occur on weekdays between 7 and 11 PM).
   vii. The average amount of in-application purchases each day, month or other designated time interval. The average may be taken over the entire life of the application on a device or over a time period such as a recent time period (the prior day, week, month, etc.).
   viii. The rate of change of in-application purchases or the currency amount of those purchases over a time interval (e.g. during the prior month the session times are increasing or the average daily session time is increasing, etc.).
i. The use of the subject application program relative to the other use or uses of the host device (e.g. 5% of device usage time is spent using the application, of game play (genre) time on the device is spent using the subject application program), which may also effectively reveal several other metrics:
   i. The average percentage of device usage time employed for the subject application during any particular time interval, e.g. day, week, month, year, ever.
   ii. The recency of a time interval where the application usage time exceeded a threshold of device usage time (e.g. the last time the subject application was over 10% of a day's device usage), potentially including: the amount of time elapsed since the last time application usage percentage exceeded a threshold; and, the average time elapsed between time intervals (e.g. days) where application usage percentage exceeded a threshold.
   iii. Overall percentage of device usage time employed for the subject application.
   iv. The average percentage of device usage time employed for the subject application over a time interval (e.g. during the last day, week, month, etc.). The average may be taken over the entire life of the application on a device or over a time period such as a recent time period (the prior day, week, month, etc.).
   v. The rate of change of application usage percentage over a time interval (e.g. during the prior month the percent application usage times are increasing or the average daily percent application usage time is increasing, etc.).
j. The geographic location of a device during any of the other observed behaviors.
k. The identity of the host device (e.g. model and brand, including software versions such as operating system version).
l. Companion applications on the device including metrics such as:
   i. The identity, genre, or other information about applications other than the subject application that are installed on the host device. Other information may include any of the information discussed regarding the subject application.
   ii. The identity, genre, or other information about applications other than the subject application that open on the host device while the subject application is in use.

Useful metrics may also include observations regarding behaviors that are less directly tied to a subject application. For example the following user and/or device behaviors may be of use in constructing a quality user profile:
a. The identity of sources for all of the software or media held by the host device (e.g. App. Stores, book stores, Audible, Amazon, Internet download, etc.).
b. The overall use pattern of the device, including for example, the local time of each device feature or software use and any pattern of use over time.
c. The user's purchase history with any particular network-accessible storefront.
d. The user's use of multiple devices (either linearly in time or contemporaneously) to access any particular network-accessible account.
e. The personal demographics of the user, such as race, religion, address, income class, etc.

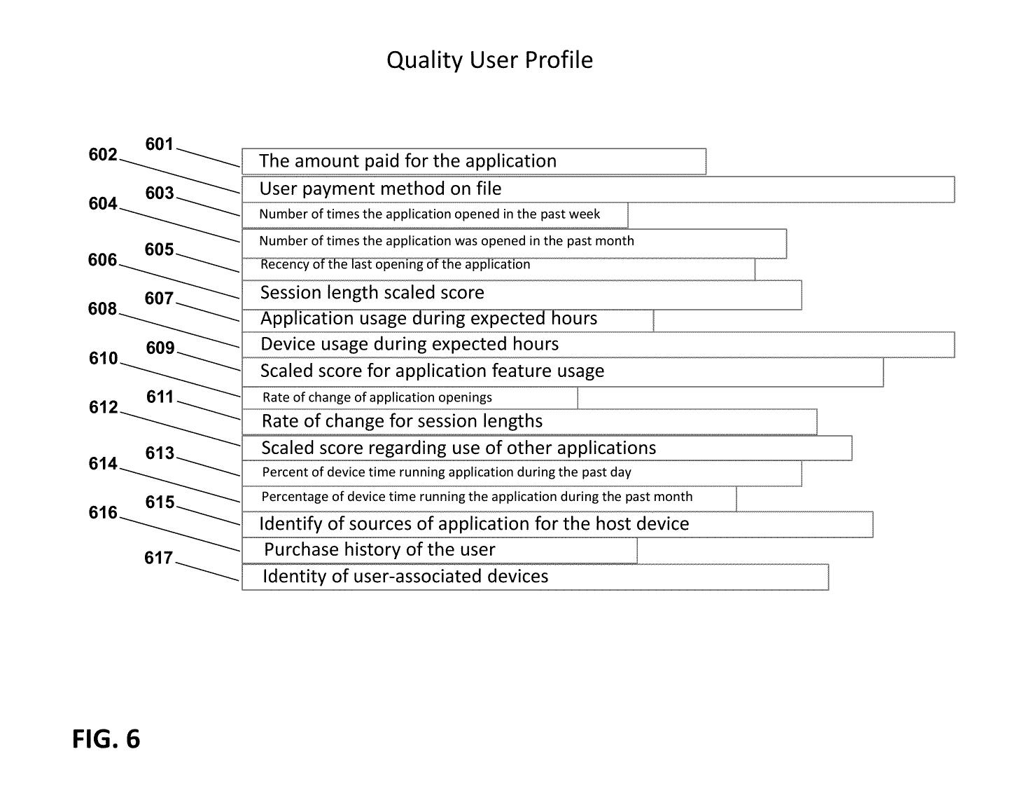

Referring now to FIG. 6, a user quality profile is shown employing specific metrics 601 to 617. Some of the metrics are represented by actual data, for example, metric 601, “the amount paid for the application.” Other metrics can be yes/no data, such as metric 602, “user payment method on file.” The quality user profile shown in FIG. 6 illustrates that some related metrics may be individually scored with data or otherwise, such as metrics 603 to 605 relating to the number of times the application has been opened. In the same profile, sets of related metrics may carry only a cumulatively scaled score determined by an algorithm or other process, such as metric 606, “session length scaled score.” As FIG. 6 exemplifies, metrics can be employed in a quality user profile in any desirable way—individually and discretely or with scoring that encompasses a category of behaviors.

After collecting or assembling quality user profiles on a variety of users (whether or not anonymized), the profiles may be correlated to assist in efforts relating to ratings, recommendations, sales and marketing, and customer satisfaction. The data for various users may be correlated employing any mathematical techniques, which are commonly known now or in the future.

Many embodiments may employ profile data to eliminate or de-rate information from users that is contrived or otherwise not representative of legitimate natural users. For example, user profiles may be eliminated or have their affects de-rated if session time data or application opening data reveals that the subject applications were too briefly used to receive a meaningful rating from the user or to consider the user's behavioral information very informative toward recommendations, customer service or other efforts. Similarly, it may be desirable to de-rate or exclude certain user's profile information if data regarding the location of use combined with session time data shows that many uses of the program were contrived, e.g. performed in collective environments in regions of the world with low labor cost and unlikely abilities to use the subject application in its native language. Alternatively, certain quality user profiles may be de-rated or eliminated on a statistical or mathematical basis. For example, certain user profiles may not fall within designated boundaries of any common profile pattern determined by analytics. In addition, mathematical concepts such as Benford's law may also be applied.

In some embodiments, the overall user profile data (or a large amount of the data) is correlated for a large number of users, and patterns are identified for which many users correlate. For example, in correlating 10,000 profiles, we may find that 200 geographically close users provided ratings for a game application within a few days of the game release, with high ratings and very little session time. These users might then be de-rated or excluded as contrived and their overall profile information can be used to identify other contrived users through correlation of other metrics (location, time, device identity, etc.). In the same manner, correlation patterns can be used to find power users of an application, or other types of users and then the other metrics from the identified group can be employed to correlate related users.

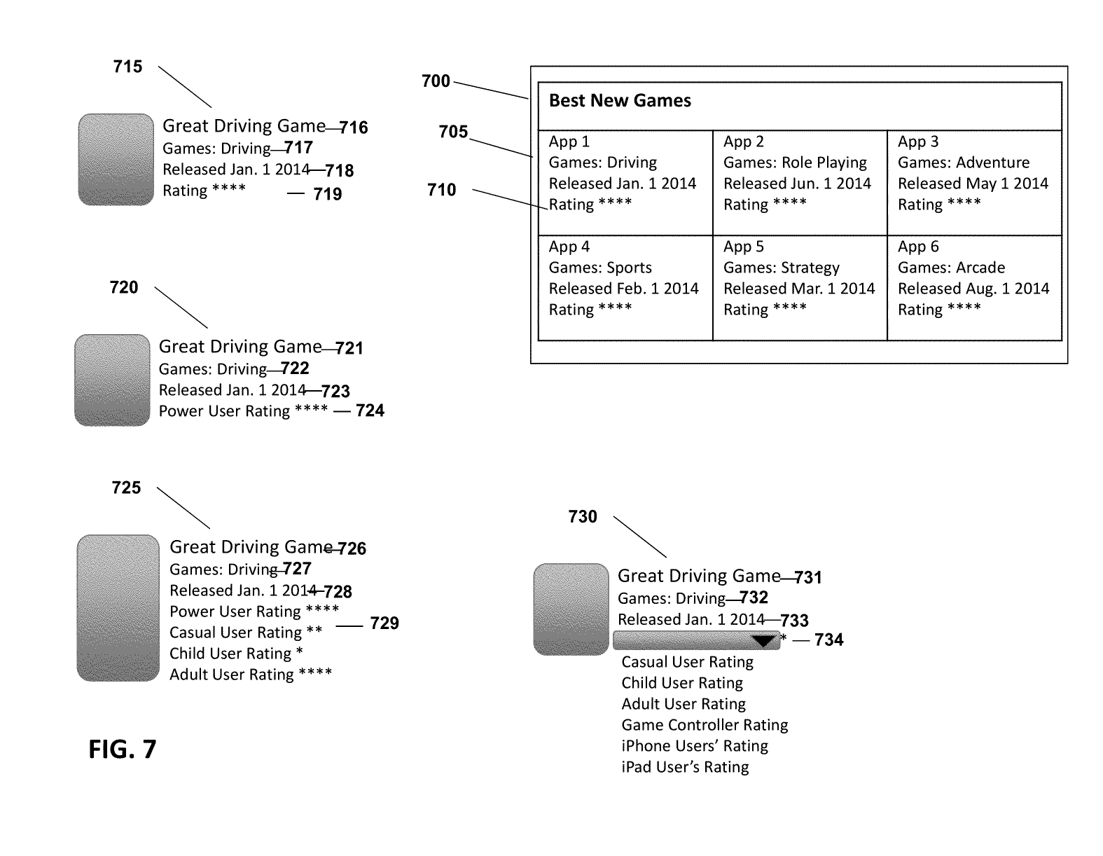

By using correlation techniques as discussed above or otherwise, application rating systems may be improved. By way of illustration, FIG. 7 shows an exemplary application store page 700 from the Apple App store or an analogous store. This illustrated store page shows advertising information 705 for each of a variety of game genre applications. Each application's advertising information contains a user rating section 710. The quality user information discussed herein as well as the correlation analysis of many user profiles can be used to enhance the quality and usefulness of this rating information. For example, in some embodiments, for any particular application program, the application's rating score may only be affected by ratings provided by users that are determined: to not be contrived; to be casual, moderate, or power users of the application. By way of illustration, the rating 719 shown in advertising information 715 may only contemplate the input of users whose quality user profile information does not correlate with contrived users. In other embodiments, if a user viewing ratings is determined to be a power user according to her quality profile, then the ratings visible to that user may rely only on other power users or may be weighted to power users. Also by way of illustration, assuming a user viewing the rating has a profile indicating that she is a power user, game information 720 shows a rating line featuring only ratings from power users. The same concept could be adopted to any type of user or application-related item, e.g. casual user, game controller user, child under 10, senior citizen, etc. Similarly, in some embodiments, for example, application information 725, the rating score interface presented to the user may show ratings information for multiple user bases (a rating by power users, another by casual users and so on). Alternatively, as illustrated in application information 730, the UI may allow the user to select the user base that provides basis for the visible recommendation. In the illustration of application information 730, a dropdown menu is shown 734 to allow the user to select the desired information base for ratings. The number of options for dividing the user base in order to give more specific ratings results are only limited by the extent of the quality user profile data. The more data that exists in each profile, the more control and specificity that may be provided to a user.

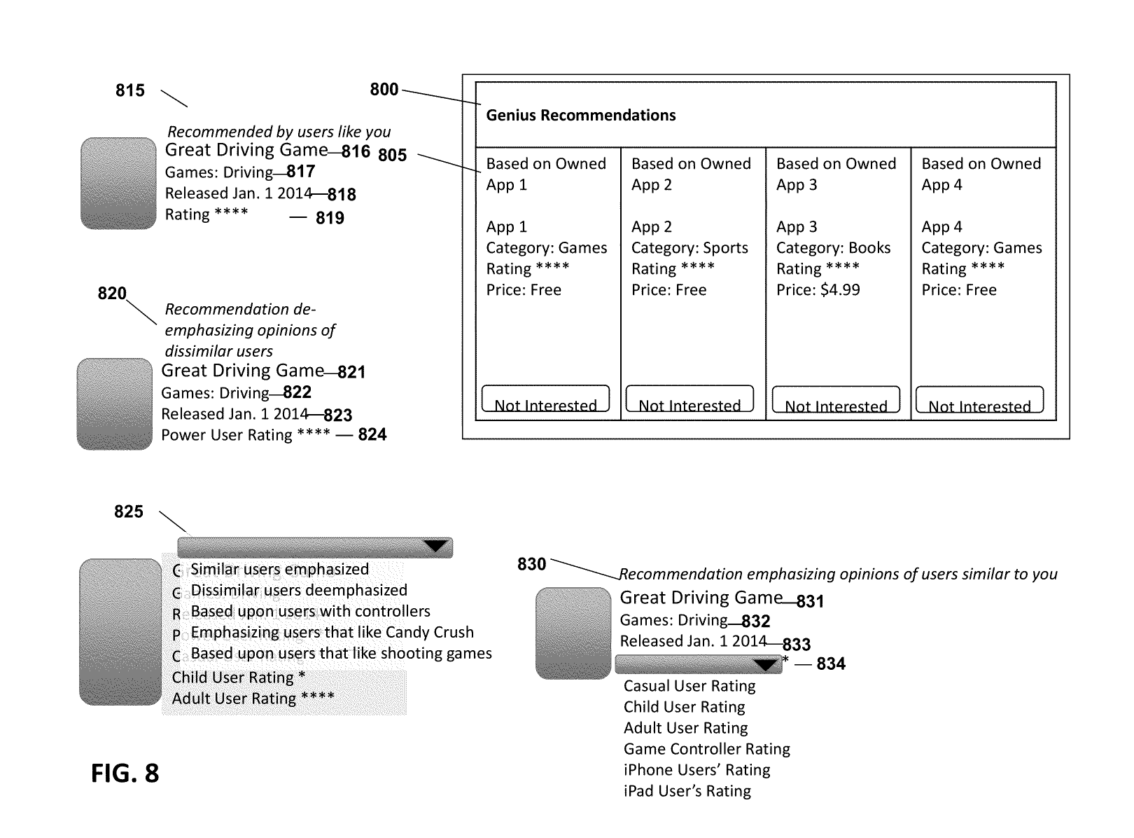

Similar to ratings, the quality user profiles and correlations of that data may be used to improve or enhance recommendations. By way of illustration, FIG. 8 shows an exemplary recommendation page 800 from an Apple App store displaying application information 805 for each of four applications that are recommended to the user based upon analysis of information the App Store knows about the user. The quality of these recommendations may be improved by using quality user information as described along with correlations of the quality user profiles. For example, recommendations to a subject (e.g. reading) user may be presented with recommendations that prioritize applications used by other users with profiles or partial profiles that correlate with the subject user. This technique might be enhanced by basing the recommendations for a particular application on other users that are both high quality users with respect to that application and have profile similarities to the reading user. A sample user interface for these concepts is illustrated as item 830 and expressly states that the recommendation emphasizes the opinions of similar users. Of course, the express qualification relating to “similar users” is optional and may be placed in the user interface so as to apply to multiple recommended applications (e.g. together in a box, in a line, on a page, etc.).

Other examples are as follows: a subject user may be presented with recommendations that only show applications used by other users with profiles or partial profiles that correlate with the subject user (optional user interface shown at 815); recommendations that present the subject user with recommendations that exclude applications used by other users with profiles that do not sufficiently correlate with the subject user (optional user interface shown at 820); recommendations that present the user with recommendations that are derived as selected by the user through the user interface (e.g. by using a checklist, dropdown or other technique as shown at 825); or, any combination of the foregoing or other use of the quality user profile data metrics that can correlate similar and dissimilar users. Furthermore, any of the options for displaying ratings on an interface may be combined with any of the options for displaying recommendations.

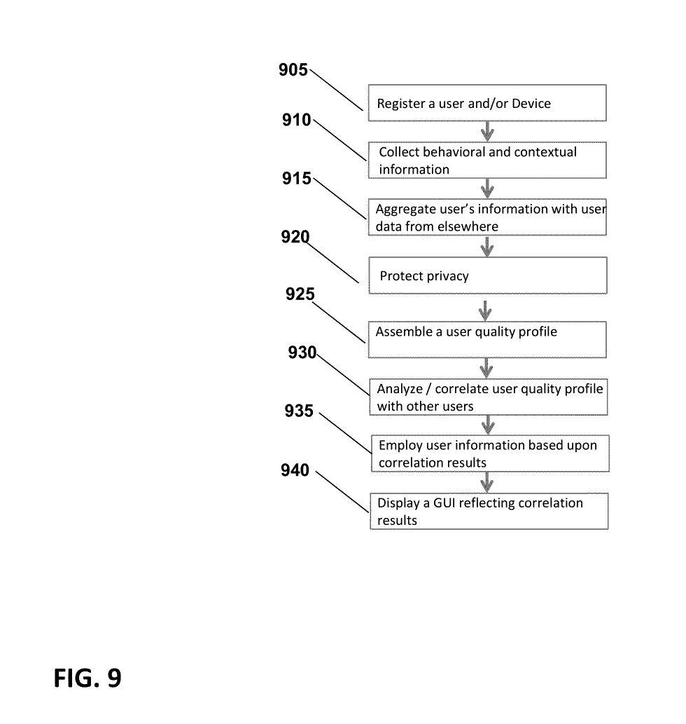

With reference to FIG. 9, a general process is shown that reflects many embodiments of the invention. The process is intended to be illustrative so that many of the concepts herein may be embodied in the diagramed process or portions of the process. According to the illustrative process, at 905 a user and/or device is identified either explicitly (e.g. by user or software registration) or implicitly (e.g. by noting activity). Either the user or the device or a combination of both may be employed as a reference for a user quality profile so that data relating to the user/device/both is associated with the reference. At 910 the process involves collecting behavioral and contextual information regarding the user/device reference. As discussed above, this data may relate to the use of an application, the device, a group of applications, or any desirable area for which it is desirable to correlate users. Moving to 915, collected data may be optionally aggregated with other information regarding the user/device. For example, account information, social media information, financial information, or other data obtained from sources outside the device(s) being monitored may be combined to form a more rich data collection. At 920, steps may be taken to protect the privacy concerns of the user. For example, consent may be obtained, or identifying information may be removed and exchanged for an anonymous indicator. Of course, any known technique for privacy protection may be employed.

At 925, a quality user profile is assembled, if it is not already implicit in the data. For example, a quality user profile may be represented by a collection of metrics regarding behavioral and contextual information about the user's/device's interaction with a program, device, group of programs, etc. Examples of quality user profiles are shown in FIGS. 5 and 6. At 930, a plurality of quality user profiles are analyzed to find correlations and patterns of user/device metrics. For example, the analysis may reveal a group of users/devices that frequently (e.g. several times each week) employ a subject application program, such as a game, for long sessions (e.g. greater than 30 minutes). Similarly, the analysis may find a group of users that provide explicit ratings for programs with very little use of those programs.

At 935, the process calls for employing user profile information in accordance with the correlation results. For example, the profiles that are frequent users of a game for long sessions may be more heavily weighted for ratings and recommendations. Alternatively, the profiles that provide ratings with little or no application use may be de-rated or ignored for ratings and recommendations. Finally, at 940, a GUI is created and/or displayed to reflect the correlation results. For example, ratings and recommendations may be collected or displayed as discussed above, at least with respect to FIGS. 7 and 8.

It is to be understood that the above description is intended to be illustrative, and not restrictive. The material has been presented to enable any person skilled in the art to make and use the invention as claimed and is provided in the context of particular embodiments, variations of which will be readily apparent to those skilled in the art (e.g., many of the disclosed embodiments may be used in combination with each other). In addition, it will be understood that some of the operations identified herein may be performed in different orders. The scope of the invention therefore should be determined with reference to the appended claims, along with the full scope of equivalents to which such claims are entitled. In the appended claims, the terms “including” and “in which” are used as the plain-English equivalents of the respective terms “comprising” and “wherein.”

We claim:

1. A method comprising the steps of:
storing ratings information or recommendation information with respect to a subject application program;
identifying a user;
using a processor to receive over a network, indications of monitored activity by the user, including user behavior and the context of the user behavior with respect to a computing device;
associating the user with the indications of the monitored activity and storing the associated data for the user in a memory;
associating a plurality of other users with respective indications of respective monitored behaviors, and storing in the memory a set of associated data for each other user;
using a second processor to analyze the associated data with the plurality of sets of associated data, the analysis yielding information correlating the user and other users with each other based upon similarities in the indications of monitored activity, wherein the monitored activity includes use of the subject application program;
altering the stored ratings information or recommendation information with respect to the subject application program based upon the information correlating users with each other.

2. The method of claim 1 wherein the processor and the second processor are the same processor.

3. The method of claim 1 wherein the indications of monitored activity by the user comprise at least three of the following:
i. a number of times that the user opened the subject application during a specified time interval;
ii. the time of day each time the user opened the subject application;
iii. the session length each time the user opened the subject application;
iv. the location of the computing device each time the user opened the subject application;
v. an indication of the amount of money used for in-application purchases for each time the user opened the subject application;
vi. the model identity of the computing device;
vii. the identity of a plurality of application programs installed on the computing device.

4. The method of claim 1 wherein information correlating the user and other users with each other based upon similarities in the indications of monitored activity comprises a plurality of groups of other users.

5. The method of claim 4 wherein at least one of the plurality of groups of other users also includes the user.

6. The method of claim 4 wherein ratings information for the user is biased to favor ratings provided by other users that are included in a group with the user.

7. The method of claim 6 wherein a group of users is a plurality of users having a correlation between user profiles.

8. The method of claim 4 wherein recommendation information for the user is biased to favor source information provided by other users that are included in a group with the user.

9. A computer readable medium comprising one or more instructions that when executed on a processor configure the processor to:
i. identify a user either implicitly or explicitly;
ii. monitor activity on a device, the monitored activity including user behavior and the context of the user behavior;
iii. record indications of the monitored activity in memory and associate the indications with the user;
iv. transmit the associated indications over a network;
v. receiving over the network ratings or recommendations information for including in a user interface; the received ratings or recommendation information being based at least in part upon a correlation analysis between the transmitted associated indications with like information associated with a plurality of other users; and
vi. presenting a user interface providing ratings or recommendations that are expressly qualified as relating to a first group of other users.

10. The computer readable medium of claim 9 wherein the user interface displays ratings for an application program and the ratings expressly indicate a bias that favors rating information obtained from the first group of other users.

11. The method of claim 10 wherein a plurality of the user's indications of monitored activity positively correlate with like information of other users represented in the first group of other users.

12. The computer readable medium of claim 9 wherein the user interface displays ratings for an application program and allows the user to choose a characteristic of the first group of other users.

13. The computer readable medium of claim 9 wherein the user interface displays ratings for an application program and the displayed ratings are based only upon ratings information received from members of the first group of other users, and wherein a plurality of the user's indications of monitored activity positively correlate with like information of other users represented in the first group of other users.

14. The computer readable medium of claim 9 wherein the user interface displays ratings for an application program and the first group of other users intentionally excludes a second group of other users, wherein the second group of other users has been determined to be contrived.

15. The computer readable medium of claim 9 wherein the user interface displays ratings for an application program and the first group of other users intentionally excludes a second group of other users, wherein a plurality of the user's indications of monitored activity negatively correlate with like information of other users represented in the second group of other users.

16. The computer readable medium of claim 9 wherein the user interface recommends an application program to the user and the recommendation expressly indicates a bias that favors rating information obtained from the first group of other users.

17. A computer readable medium comprising one or more instructions that when executed on a processor configure the processor to:
store ratings information or recommendation information with respect to a subject application program;
identify a plurality of users, each user identified either implicitly or explicitly;
receive over a network data regarding metrics associated with each user, each metric representing an aspect of use of the subject application program or an aspect of the context of such use;
storing the data in a memory such that each of the plurality of users is associated with respective metric data;
correlating the data among the plurality of users such that a plurality of groups of users are identified, each group of users indicated by a positive correlation regarding a plurality of metrics;
alter the ratings information or recommendation information with respect to the subject application program based upon the correlation information.

18. The computer readable medium of claim 17 wherein ratings or recommendation information is altered to exclude information contributed from users that are determined to be contrived.

19. The computer readable medium of claim 17 wherein ratings for presentation to a second user are altered to be biased in favor of information contributed from users that are members of at least one group that includes the second user.

20. The computer readable medium of claim 17 wherein recommendations for presentation to a second user are altered to be biased in favor of information contributed from users that are members of at least one group that includes the second user.
